(19) United States
(12) Patent Application Publication
(10) Pub. No.: US 2007/0005491 A1
(43) Pub. Date: Jan. 4, 2007

(54) Method for depositing a credit on an account associated to a terminal subscribed to a communication network

(76) Inventor: Kati A. Koho, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/518,242

(22) PCT Filed: Jun. 18, 2002
(86) PCT No.: PCT/IB02/02237

§ 371 Date: Aug. 10, 2005

(51) Int. Cl. G06Q 40/00

(52) U.S. Cl. 705/38; 705/35

(57) ABSTRACT

The present invention concerns a method for depositing a credit on an account associated to a terminal subscribed to a communication network, the method comprising the steps of: interacting (1) between the terminal and a network entity, wherein said interacting yields an indication of at least whether a credit is to be deposited on said account associated to said terminal, an amount of credit to be deposited and a source of the deposit, requesting (2) from said network entity to said source of the deposit, to deposit said amount of credit on an account associated to said terminal, wherein said requesting is based on the DIAMETER protocol.

### TITLE OF THE INVENTION

Method for depositing a credit on an account associated to a terminal subscribed to a communication network

### FIELD OF THE INVENTION

The present invention relates to a method for depositing a credit on an account associated to a terminal subscribed to a communication network.

### BACKGROUND OF THE INVENTION

Recently, communication networks and services offered using such communication networks have made considerable progress. Among such services, so-called value-added services find increasing attention among subscribers to the communication network.

Subscribers to the network are registered to the network and normally pay the network operator for using services offered by the communication network. Such a payment is either regularly billed to the subscriber's account, e.g. per month, or deducted from his pre-paid account. If the prepaid account does not show a certain minimum credit any longer, the subscriber will be barred from further using the network until he has recharged his'account.

Recharging a prepaid account can be accomplished for example by paying a certain amount to be recharged to a third party and receiving a code, which —when entered—enables the user to recharge his prepaid account by his terminal. The third party in turn transfers the money received from the subscriber to the network operator.

Such a procedure is quite cumbersome. Also, the third party generally retains some of the money the user paid for the services offered by the third party to the user/network operator. Thus, costs to be paid by the subscriber will rise accordingly.

Likewise, in case the subscriber participates in a quiz or a lottery using his terminal (e.g. mobile phone or user equipment), the procedures involved upon a winning subscriber are quite cumbersome and require “paper work”. The subscriber has to indicate his name/address and/or bank account so that he may receive a bank check and/or that the money is transferred to his bank account.

In summary, currently adopted procedures for depositing a credit on an account associated to a terminal subscribed to a communication network are cumbersome and involve human activities which makes the whole procedure time consuming and more expensive.

### SUMMARY OF THE INVENTION

Consequently, it is an object of the present invention to provide an improved a method for depositing a credit on an account associated to a terminal subscribed to a communication network.

According to the present invention, the above object is for example achieved by a method for depositing a credit on an account associated to a terminal subscribed to a communication network, the method comprising the steps of: interacting between the terminal and a network entity, wherein said interacting yields an indication of at least whether a credit is to be deposited on said account associated to said terminal, an amount of credit to be deposited and a source of the deposit, requesting from said network entity to said source of the deposit, to deposit said amount of credit on an account associated to said terminal, wherein said requesting is based on the DIAMETER protocol.

According to favorable further developments

said interacting is based on a value-added multimedia application run on a multimedia application server provided in said network,

said requesting comprises generating a DIAMETER request message identifying the request as a request for depositing an amount to an account,

said generated DIAMETER request message further includes an attribute value pair identifying the terminal to an associated account of which the deposit is to be deposited, an attribute value pair identifying said source of the deposit, and an attribute value pair identifying the amount of said deposit,

the DIAMETER request message is routed from said network entity to said source based on said attribute value pair identifying said source of the deposit,

the method comprises a step of acknowledging, by said source, whether said request was successful or not to said requesting network entity,

the method further comprises a step of depositing said amount to said account associated to said terminal upon receiving an acknowledgment indicating success,

the method further comprises a step of informing said terminal of the amount being deposited to an account associated to said terminal.

By virtue of the present invention, basically the following advantages can be achieved:

with the proposed modifications to the DIAMETER protocol, it can be adopted for on-line charging purposes e.g. in the IP Multimedia Subsystem IMS of communication networks,

making a deposit on a subscriber's account, i.e. an account associated to a terminal used by the subscriber can be effected using the DIAMETER protocol,

on-line charging and/or depositing of an amount can be effected without involving a third party (vendor at a shop or the like) to become active as the service provider can upload winnings immediately to the account associated to the user's terminal (e.g. a prepaid account), thereby saving administrative work,

services involving on-line charging/depositing benefit from the simplification of the charging/depositing emerging from the proposed invention,

new services such as games/quizzes or lotteries can easily be implemented to be carried out interactively by a subscriber using his terminal.

### BRIEF DESCRIPTION OF THE DRAWINGS

In the following, the present invention will be described in greater detail with reference to the accompanying drawings, in which

FIG. 1 shows a simplified signal flow of the steps involved upon the present invention being implemented.

### DETAILED DESCRIPTION OF THE EMBODIMENTS

According to the present invention, in order to enable the deposit of an amount of money, or generally a credit of units (which need not necessarily correspond to money) to an account associated to the terminal through an interface between a network element NE and an Account Server, a new mechanism is introduced. The new mechanism relies for example on the DIAMETER protocol. It involves in that case a new DIAMETER request including an indication that the request is a deposit/credit to the account and also a new Attribute Value Pair AVP indicating the source of the deposit/credit. The answer message indicates to the network element whether the request was successful or not. It has to be noted that ACR as such is not a new request, this is just a new “mechanism” in connection with which also the amount of the deposit must be indicated as well as the identity of the subscriber.

As regards the DIAMETER protocol on which the present invention for example relies, Diameter is an AAA (Authentication, Authorization and Accounting) protocol specified in IETF. By virtue of the present invention, DIAMETER is adapted to be used for on-line charging in communication networks, for example in connection with the IP Multimedia Subsystem IMS. The All-IP network (IP=Internet Protocol) will offer many new services. This invention enables DIAMETER to be used for making a deposit on the user's account, thus introducing a quite useful feature for some services. For example, this mechanism supports some services such as games/lotteries performed via the communication network; more precisely, the subscriber could win something i.e. in a game and the service provider/network operator could upload the winnings immediately to a user's account such as a prepaid account. This solution would also provide a benefit to the operators since the money would go directly to the prepaid account and would thus be spent again for communication services.

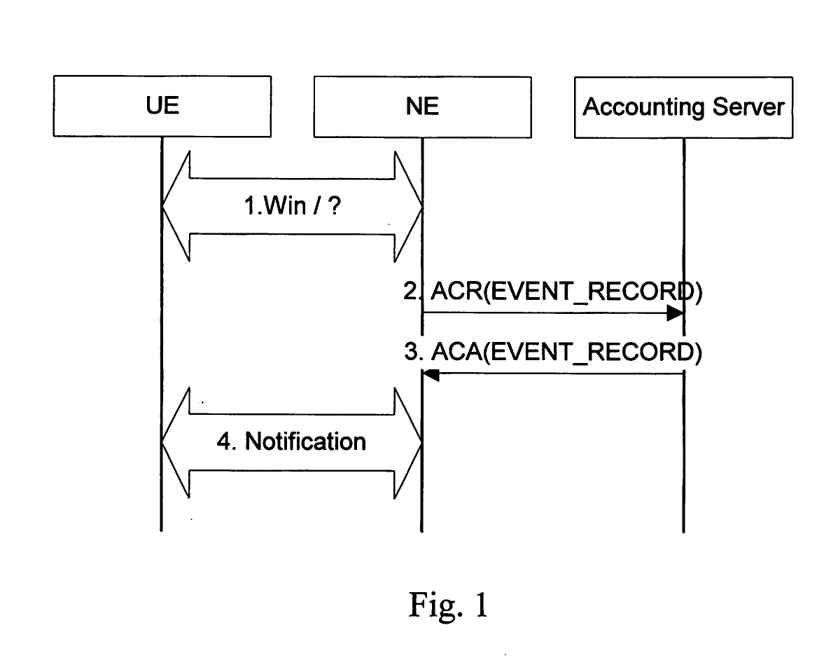

This will be explained in still greater detail with reference to FIG. 1. FIG. 1 illustrates (horizontally arranged) entities involved in connection with the present invention and signaling there between. In vertical direction, the succession of the signaling with lapse of time is represented. As regards the entities involved, FIG. 1 shows a user equipment UE (e.g. according to UMTS) as an example for a terminal. The terminal has subscribed to a communication network represented by at least one network element NE. It has to be noted that the network element NE shown in FIG. 1 may combine several functionalities of the network, which for simplification of the drawing and explanation are not shown as individual functional network entities. Furthermore, an accounting server is shown which is involved in connection with the present invention.

Associated to the terminal is an account for depositing a credit thereon. This account can be a pre-paid account maintained for the terminal/subscriber at the network operator (e.g. in connection with subscriber data maintained at the HLR (Home Location Register)/HSS (Home Subscriber Server). Nevertheless, another account is also possible, e.g. a bank account associated to the terminal/user so that e.g. the subscriber ID (e.g. telephone number) is mapped to a bank account number. In the latter case, additional routing/rerouting will be involved in order that the deposit is made on the account associated to the terminal.

In a first step (1.), there is an interaction between the terminal and a network entity. The interaction may comprise the bi-directional exchange of data between these and may reside in a game/lottery or the like in which the subscriber participates by means of his terminal. The interacting is for example based on a value-added multimedia application run on a multimedia application server provided in said network. (Note that the network element NE is assumed to comprise this server in the illustration according to FIG. 1).

As a result, in case the user wins in the game or something similar, said interacting yields an indication of at least that a credit is to be deposited an said account associated to said terminal, an amount of credit to be deposited and a source of the deposit. The source of the credit to be deposited here means the party who runs the game/lottery, more precisely, the party is represented by an accounting server associated to the third party and in charge for the payment of the credits to the winners. The third party is represented by the network entity NE with which the interaction takes place. For example, in case a plurality of games is offered to be played, the user equipment UE interacts with a selected network entity out of a corresponding plurality of network entities. Allocated to the respectively selected network entity there is at least one accounting server in charge of depositing the deposit to the account associated to the user equipment. The network element decides where the request is to be routed to, i.e. to which accounting server. This decision/selection can be based on e.g. the subscriber information (e.g. in case of plural accounting servers per network entity) and/or based on the address or identity of the network element NE (e.g. if plural games can be played each involving a respective network entity operated by a third party). If only one accounting server is provided for, then the routing is easy while however the requesting network entity has to be indicated in the request (using a new AVP for this purpose). To clarify, the source of the deposit viewed from the terminal's/user's account is the accounting server, while the accounting server always has a knowledge of the origin of the deposit he makes, i.e. of the identity of the third party with which the terminal has interacted by e.g. playing a game. Thereafter, in a second step (2.), it is requested from said network entity NE to said source (here: accounting server) of the deposit, to deposit said amount of credit on an account associated to said terminal. (Note that the amount of credit deposited to the account associated to the terminal will correspondingly be debited to an account associated to the third party/network element, i.e. the origin of the amount to be deposited.) This requesting is based on the DIAMETER protocol. Note that in FIG. 1, the network element NE may take care of the functionalities of a DIAMETER client, DIAMETER server as well as DIAMETER proxy agent, if required according to the circumstances.

It is to be noted that DIAMETER has been chosen as an example only for this embodiment of the present invention. Other AAA protocols such as RADIUS (Remote Authentication Dial In User Service) or any other suitable AAA protocol could be accordingly adapted as proposed by the present invention. A brief introduction to DIAMETER can for example be found in “Authentication, Authorization and Accounting in Session Initiation Protocol Networks” by Aki Niemi, Master's Thesis at the Helsinki University of Technology (HUT), Mar. 7, 2002 (retrieved from the Internet on Jun. 3, 2002), pages 26 to 36.

This request is based on a generated DIAMETER request message (ACR(Event_Record)) identifying the request as a request for depositing an amount to an account. To this end, a new request identity in the DIAMETER protocol is defined. Stated in other words, more precisely, in case of DIAMETER protocol, the command code identifies the command and here an existing Diameter request (ACR, Accounting Request) is used. Also an existing AVP (Accounting-Record-Type) is used (its value is event_record in this case). In addition to this, some indication (a new Attribute Value Pair AVP, i.e. some specific AVP used only for this service) is needed that will indicate that the purpose of the request is to deposit an amount of e.g. money to an account. The thus identified generated DIAMETER request message further includes a (newly defined) attribute value pair AVP identifying the terminal (here UE) to an associated account of which the deposit is to be deposited, an attribute value pair identifying said source of the deposit (i.e. the account server), and an attribute value pair identifying the amount of said deposit. Note that in case plural accounts are associated to one terminal, the terminal identification additionally includes an indication of the account concerned. For example, in case of a terminal being used by several users, each entering a personal identification code when taking the terminal in use, the account concerned can be distinguished based on the user's ID. Thus, not only the terminal as such but also the account concerned is then included in the AVP in case plural accounts are associated to the terminal.

This DIAMETER request message is routed from said network entity NE to said source based on said attribute value pair identifying said source of the deposit. In FIG. 1, only one accounting server is shown for simplicity of the drawing. Nevertheless, in case more than one accounting server is available in the entire network, the request is routed to the “correct” one identified by the AVP. The entry into the AVP thus represents an address for routing.

Upon receipt of the request in step 2, the source acknowledges in step 3., whether said request was successful or not to said requesting network entity. This acknowledgment is returned in an ACA Event_Record message according to the DIAMETER protocol. Also for this message, a suitable result code covering possible results to be informed to the requesting network element is newly defined. In case of a positive acknowledgment, i.e. upon receiving an acknowledgment indicating success, a step of depositing said amount to said account associated to said terminal is performed. This step is not shown separately but is performed at the network element upon evaluation of the acknowledgment. That is, the network element has already knowledge of the terminal/account concerned and of the amount to be deposited and performs the depositing upon a confirmation to do so (positive acknowledgment).

Finally, according to the proposed method, informing said terminal of the amount being deposited to an account associated to said terminal is performed in step 4. This informing needs not to rely on any specific protocol requirements. For example, it can be effected using a similar multi-media application as in step 1. The user of the terminal has then knowledge of his updated account balance upon the amount being deposited.

Thus, one advantageous application of the present invention resides in e.g. IP Multimedia services, where Diameter is adopted for online charging. In this way, a multimedia application server (e.g. game server) could use the same Diameter charging connection to the account for depositing winnings and no separate connections are needed.

Accordingly, has been described above, the present invention concerns a method for depositing a credit on an account associated to a terminal subscribed to a communication network, the method comprising the steps of: interacting 1 between the terminal and a network entity, wherein said interacting yields an indication of at least whether a credit is to be deposited on said account associated to said terminal, an amount of credit to be deposited and a source of the deposit, requesting 2 from said network entity to said source of the deposit, to deposit said amount of credit on an account associated to said terminal, wherein said requesting is based on the DIAMETER protocol.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method for depositing a credit on an account associated to a terminal subscribed to a communication network, the method comprising the steps of:
interacting (1) between the terminal and a network entity, wherein said interacting yields an indication of at least whether a credit is to be deposited on said account associated to said terminal, an amount of credit to be deposited and a source of the deposit,
requesting (2) from said network entity to said source of the deposit, to deposit said amount of credit on an account associated to said terminal,
wherein said requesting is based on the DIAMETER protocol.

2. A method according to claim 1, wherein said interacting is based on a value-added multimedia application run on a multimedia application server provided in said network.

3. A method according to claim 1, wherein said requesting (2.) comprises
generating a DIAMETER request message identifying the request as a request for depositing an amount to an account.

4. A method according to claim 3, wherein said generated DIAMETER request message further includes
an attribute value pair identifying the terminal to an associated account of which the deposit is to be deposited,
an attribute value pair identifying said source of the deposit, and
an attribute value pair identifying the amount of said deposit.

5. A method according to claim 4, wherein
the DIAMETER request message is routed from said network entity to said source based on said attribute value pair identifying said source of the deposit.

6. A method according to claim 1, further comprising a step of
acknowledging (3.), by said source, whether said request was successful or not to said requesting network entity.

7. A method according to claim 6, further comprising a step of depositing said amount to said account associated to said terminal upon receiving an acknowledgment indicating success.

8. A method according to claim 7, further comprising a step of informing (4.) said terminal of the amount being deposited to an account associated to said terminal.
